(19) United States
(12) Patent Application Publication
(10) Pub. No.: US 2026/0371393 A1
(43) Pub. Date: Nov. 19, 2026

(54) ASSISTANCE INFORMATION INTERACTION METHOD AND APPARATUS

(71) Applicant: Beijing Xiaomi Mobile Software Co., Ltd., Beijing (CN)

(72) Inventors: Xiaowei JIANG, Beijing (CN); Xing YANG, Beijing (CN)

(73) Assignee: Beijing Xiaomi Mobile Software Co., Ltd., Beijing (CN)

(21) Appl. No.: 19/470,472

(22) PCT Filed: Mar. 31, 2023
(86) PCT No.: PCT/CN2023/085772

§ 371 Date: Sep. 29, 2025

(51) Int. Cl. H04W 74/0816; H04W 72/25; H04W 76/23

(52) U.S. Cl. CPC H04W 74/0816; H04W 72/25; H04W 76/23

(57) ABSTRACT

Methods, devices, and media for assistance-information interaction to coordinate sidelink shared channel occupancy time (COT). A first terminal determines assistance information for a second terminal that initiates shared COT, and transmits the information via multicast or broadcast using a target address for a common service, or periodically with a period from network configuration, local implementation, or the second terminal. The first terminal may select the second terminal when a unicast link exists and either RSRP exceeds a threshold or pending SL data exists. Reporting may be triggered by assistance-information changes or initial setup of unicast/multicast/broadcast services. Upon request, a timer controls generation/sending; with network dynamic scheduling and no SL resources, a scheduling request is triggered. Assistance information (e.g., traffic pattern/periodicity, timing offset, packet size, QoS ID, priority, target address) is carried via PC5 RRC, SL MAC CE, or SCI.

### CROSS-REFERENCE TO RELATED APPLICATION

The present application is a U.S. National Stage of International Application No. PCT/CN 2023/085772, filed on Mar. 31, 2023, the contents of all of which are incorporated herein by reference in their entirety for all purposes.

### BACKGROUND OF THE INVENTION

To support direct communication between terminals, a direct communication (also referred to as sidelink (SL)) mode is introduced, and the interface between the terminals is a PC-5 interface. According to a correspondence relationship between a sending terminal and a receiving terminal, three transmission modes, such as unicast, multicast, and broadcast, are supported on the sidelink.

For the sidelink in R18, operation in an unlicensed spectrum is supported. An unlicensed spectrum can be used for sidelink communication. The unlicensed spectrum is open and can be effectively utilized to improve performance and rate. A communication device can contend for resources and communicate via the contested unlicensed band resources.

The sharing of channel occupancy time (COT) is a feature currently under discussion in R18. A type 1 listen before talk (LBT) terminal can preempt and share the COT with another terminal. The type 1 LBT is based on a contention window, and a random number determines the channel listening duration. Access to a channel is completed only when the random number equals 0 and the channel is idle. In addition, a terminal initiating shared COT is referred to as a COT initiating UE, and a terminal using the shared COT is referred to as a responding terminal or responding UE.

### SUMMARY OF THE INVENTION

The present disclosure relates to the technical field of communication, and in particular, to a method and device for assistance information interaction.

In a first aspect, the embodiments of the present disclosure provide a method for assistance information interaction. The method is performed by a first terminal, and the method includes:
determining assistance information, where the assistance information is configured to assist a second terminal in sharing acquired channel occupancy time (COT) with the first terminal, and the second terminal is a terminal initiating shared COT; and sending the assistance information to the second terminal.
In a second aspect, the embodiments of the present disclosure provide another method for assistance information interaction. The method is performed by a second terminal, and the method includes:
receiving assistance information sent by a first terminal, where the assistance information is configured to assist the second terminal in sharing acquired channel occupancy time (COT) with the first terminal, and the second terminal is a terminal initiating shared COT.

In a third aspect, the embodiments of the present disclosure provide a communication device. The communication device includes one or more processors and a memory, where a computer program is stored in the memory, and the one or more processors collectively execute the computer program stored in the memory, so as to cause the communication device to perform the method in the first aspect.

In a fourth aspect, the embodiments of the present disclosure provide a communication device. The communication device includes one or more processors and a memory, where a computer program is stored in the memory, and the one or more processors collectively execute the computer program stored in the memory, so as to cause the communication device to perform the method in the second aspect.

In a fifth aspect, the embodiments of the present disclosure provide a non-transitory computer-readable storage medium. The computer-readable storage medium is configured to store instructions used for a first terminal, and the instructions, when executed, cause the first terminal to perform the method in the first aspect.

In a sixth aspect, the embodiments of the present disclosure provide a non-transitory computer-readable storage medium. The readable storage medium is configured to store instructions used for a second terminal, and the instructions, when executed, cause the second terminal to perform the method in the second aspect.

### BRIEF DESCRIPTION OF DRAWINGS

In order to more clearly describe technical solutions in the embodiments or the background art of the present disclosure, the accompanying drawings needed to be used in the embodiments or the background art of the present disclosure will be described below.

FIG. 1 is a schematic architecture diagram of a communication system according to an embodiment of the present disclosure;

FIG. 2 is a schematic flowchart of a method for assistance information interaction according to an embodiment of the present disclosure;

FIG. 3 is a schematic flowchart of yet another method for assistance information interaction according to an embodiment of the present disclosure;

FIG. 4 is a schematic flowchart of a configuration method according to an embodiment of the present disclosure;

FIG. 5 is a schematic flowchart of yet another method for assistance information interaction according to an embodiment of the present disclosure;

FIG. 6 is a schematic structural diagram of a communication device according to an embodiment of the present disclosure;

FIG. 7 is a schematic structural diagram of another communication device according to an embodiment of the present disclosure; and

FIG. 8 is a schematic structural diagram of a chip according to an embodiment of the present disclosure.

### DETAILED DESCRIPTION OF THE INVENTION

The embodiments of the present disclosure will be described in detail below, and instances of the embodiments are shown in the accompanying drawings. The identical or similar reference numerals indicate identical or similar elements or elements having identical or similar functions throughout. The embodiments described below with reference to the accompanying drawings are illustrative and are intended to explain the present disclosure, but should not be construed as limitation to the present disclosure. In the description of the present disclosure, unless otherwise specified, “/” indicates or, for example, A/B can indicate A or B. The “and/or” here merely describes an association relation of associated objects, and indicates that there can be three relations. For example, A and/or B can indicate that A exists independently, A and B exist simultaneously, or B exists independently.

Terms used in the embodiments of the present disclosure are merely used for describing specific embodiments rather than limiting the embodiments of the present disclosure. Singular forms such as “a,” “an,” “the,” and “this” used in embodiments and the appended claims of the present disclosure are also intended to include plural forms, unless otherwise clearly stated in the context.

It should be understood that although terms such as first, second, and third can be used in the embodiments of the present disclosure to describe different types of information, the information should not be limited to these terms. These terms are merely used to distinguish the same type of information from each other. For example, first information can be referred to as second information and second information can be referred to as first information similarly without departing from the scope of the embodiments of the present disclosure. Depending on the context, the word “if” as used here can be interpreted as “at the time of,” “when,” or “in response to determining.”

In order to facilitate understanding, the terms involved in the present disclosure are introduced at first.

### 1. Initiating Terminal of Shared Channel Occupancy Time (COT)

The initiating terminal of the shared COT (COT initiating UE) refers to a terminal initiating the shared COT.

### 2. Responding Terminal of the Shared COT

The responding terminal of the shared COT (COT responding UE) refers to a terminal using the shared COT. For example, in a case where the responding terminal is a target receiving terminal of the COT initiating terminal, the responding terminal may share the COT. The responding terminal is the target receiving terminal of the COT initiating terminal, it means that at least one of the following is satisfied: a target address indicated in sidelink control information (SCI) of the shared COT initiated by the initiating terminal is an address of the responding terminal, or a target terminal identifier indicated by shared COT indication information in the SCI is a terminal identifier of the responding terminal. As an instance, the responding terminal may be the responding user equipment. The responding terminal of the shared COT may alternatively be referred to as a target terminal of the shared COT.

### 3. Sidelink-Unlicensed (Sidelink-U) Scenario

The Sidelink-U scenario indicates that sidelink communication may use an unlicensed spectrum. The unlicensed spectrum is open, and may be used effectively to improve in performance and rate. A communication device can contend for resources and communicate on unlicensed band resources obtained in resource contention.

The embodiments of the present disclosure are described in detail below, and instances of the embodiments are shown in the accompanying drawings. Identical or similar reference numerals indicate identical or similar elements throughout. The embodiments described below with reference to the accompanying drawings are illustrative and are intended to explain the present disclosure, but should not be construed as limitation to the present disclosure.

To support direct communication between terminals, a direct communication (also referred to as sidelink (SL)) mode is introduced, and an interface between the terminals is a PC-5 interface. According to a correspondence relationship between a sending terminal and a receiving terminal, three transmission modes, such as unicast, multicast, and broadcast, are supported on the sidelink. The sending terminal sends the sidelink control information (SCI) on a physical sidelink control channel (PSCCH) and sends second-stage SCI on a physical sidelink shared channel (PSSCH). A resource location, a source identifier, a target identifier, etc. for transmission data are carried. For a hybrid automatic repeat request (HARQ) feedback enabled data packet, the receiving terminal performs hybrid automatic retransmission request acknowledgement (HARQ-ACK) feedback for the PSSCH on a physical sidelink feedback channel (PSFCH).

The sidelink communication has two allocation modes of sending resources: a network dynamic scheduling mode (mode 1) and a mode (mode 2) in which the UE independently selects in a network-configured or pre-configured resource pool. In a case of the dynamic scheduling, the network dynamically allocates sending resources on the sidelink to the UE according to a buffered data report by the UE. In a case of independent selection, the UE randomly selects the sending resource from the network-configured or pre-configuration resource pool. The network may configure a plurality of resource pools for the UE on one bandwidth part (BWP). Specific allocation mode is configured by a network side via radio resource control (RRC) signaling.

The sidelink in R16/17 supports the terminal that runs in the mode 1 to provide an SL-buffer status report (BSR) for the network device, and assists the network device in scheduling SL resources. The SL-BSR includes a periodic SL-BSR and a regular SL-BSR. The NR-U (also referred to as 5G NR-U, 5G New Radio in Unlicensed Spectrum, License free band 5G NR) is a project of 3rd generation partnership project (3GPP) in R16, and provides necessary technology for operators to fully integrate unlicensed spectrum into 5G networks. The NR-U supports an uplink operation and a downlink operation in an unlicensed band. In the NR-U, a downlink channel access and an uplink channel access depend on a listen before talk (LBT) feature. A wireless device or a base station needs to “sense” a communication channel at first and find that there is no communication before any transmission. In a case where one communication channel is an unlicensed broadband carrier (for example, several hundred megahertz), the LBT process depends on energy level measurement on a plurality of sub-bands of the communication channel. LBT parameters (such as a type/duration and a clear channel assessment parameter) are configured by the base station on the wireless device. Types of the LBT include a type 1 and a type 2. The type 1 is based on a contention window, and duration of channel listening is determined by a random number. Access to a channel is completed only when the random number is equal to 0 and the channel is idle. LBT in the type 2 uses the channel listening based on a fixed time period, such as 25 us and 16 us. A channel access priority class (CAPC) is a parameter related to the LBT. Different CAPCs affect priority during channel competition. The less the CAPC value is, the higher the priority is.

It is worth noting that the sharing of channel occupancy time (COT) is a feature under discussion in the R18. A terminal for type 1 listen before talk (LBT) is allowed to preempt and share the COT with another terminal. However, a particular requirement exists for the terminal available for sharing the COT. A terminal initiating the shared COT is referred to as COT initiating UE, and a terminal using the shared COT is referred to as a responding terminal or a responding UE.

However, in a sidelink-unlicensed (Sidelink-U) scenario, how to avoid waste of the COT by allowing the responding terminal to use the COT shared by the initiating UE is a pressing problem to be solved.

In view of that, the embodiments of the present disclosure provide a method and device for assistance information interaction, and a configuration method. Based on information interaction between a responding terminal and an initiating terminal of shared COT, the initiating terminal can know service information of the responding terminal. The initiating terminal of the shared COT is assisted in sharing acquired COT with a first terminal (that is, the responding terminal of the COT), and then the first terminal can use the shared COT send data. Thus, waste of the COT is avoided.

In order to better understand the method and device for assistance information interaction, and the configuration method in the embodiment of the present disclosure, a communication system applicable to the embodiment of the present disclosure will be described below at first.

With reference to FIG. 1, FIG. 1 is a schematic architecture diagram of the communication system according to the embodiment of the present disclosure. The communication system may include, but is not limited to, one network device and two terminals. A number of devices and forms of the devices shown in FIG. 1 are illustrative and do not constitute limitation to the embodiment of the present disclosure. In actual application, two or more network devices and three or more terminals may be included. For example, the communication system shown in FIG. 1 includes one network device 101 and two terminals (such as a terminal 102 and a terminal 103).

It should be noted that the technical solutions of the embodiments of the present disclosure may be applied to various communication systems, for example, a long-term evolution (LTE) system, a 5th generation (5G) mobile communication system, a 5G new radio (NR) system, or another future new mobile communication systems. It should also be noted that the sidelink in the embodiment of the present disclosure may also be referred to as a side link or a direct link.

The network device 101 in the embodiment of the present disclosure is an entity at a network side for transmitting or receiving a signal. For example, the network device 101 may be an evolved NodeB (eNB), a transmission reception point (TRP), a next generation NodeB (gNB) in the NR system, and a base station in another future mobile communication system or an access node in a wireless fidelity (WiFi) system. A specific technology and a specific device form adopted by the network device are not limited in the embodiment of the present disclosure. The network device according to the embodiment of the present disclosure may be composed of a centralized unit (CU) and a distributed unit (DU). The CU may also be referred to as a control unit. By adopting the structure of CU-DU, a protocol layer of the network device (such as the base station) may be separated, functions of some protocol layers are under centralized control by the CU, functions of the remaining protocol layers or all protocol layers are distributed in the DU, and the DU is under centralized control by the CU.

The terminal 102 and the terminal 103 in the embodiment of the present disclosure are entities at a user side for receiving or transmitting the signal, such as a mobile phone. It should be noted that the terminal in the embodiment of the present disclosure may also be understood as user equipment or a terminal device. That is, the terminal in the embodiment of the present disclosure may alternatively be referred to as the terminal, the user equipment (UE), a mobile station (MS), a mobile terminal (MT), etc. The terminal may be an automobile having a communication function, an intelligence automobile, a mobile phone, a wearable device, a tablet computer (Pad), a computer having wireless transceiving functions, a virtual reality (VR) terminal, an augmented reality (AR) terminal, a wireless terminal in industrial control, a wireless terminal in self-driving, a wireless terminal in remote medical surgery, a wireless terminal in a smart grid, a wireless terminal in transportation safety, a wireless terminal in a smart city, a wireless terminal in a smart home, etc. A specific technology and a specific device form adopted by the terminal are not limited in the embodiment of the present disclosure.

Optionally, the first terminal mentioned in the embodiment of the present disclosure may refer to the terminal 102 and the second terminal may refer to the terminal 103. As an instance, one or more first terminals and one or more second terminals mentioned in the embodiment of the present disclosure may be provided.

It can be understood that the communication system described in the embodiment of the present disclosure is used for more clearly describing the technical solution of the embodiment of the present disclosure, but does not constitute limitation to the technical solution according to the embodiment of the present disclosure. It is conceivable to those skilled in the art that along with the evolution of the system architecture and the emergence of a new service scenario, the technical solution according to the embodiment of the present disclosure is also applicable to similar technical problems.

In a sidelink-unlicensed (sidelink-U) scenario, how to avoid the waste of the COT by allowing the responding terminal to use the COT shared by the initiating UE is a pressing problem to be solved.

Embodiments of the present disclosure provide a method and device for assistance information interaction, which can be applied to Internet of Vehicles, such as vehicle-to-everything (V2X) communication, long-term evolution-vehicle (LTE-V), and vehicle-to-vehicle (V2V) communication, or can be used in the fields of intelligent driving, intelligent connected vehicles, etc. By reporting assistance information to an initiating terminal of channel occupancy time (COT), the initiating terminal is assisted in sharing preempted COT with a terminal reporting the assistance information, and a responding terminal of the COT can be supported to use shared COT to send sidelink data to the initiating terminal of the COT. Thus, the waste of the COT is avoided.

The method and device for assistance information interaction, and the configuration method according to the present disclosure will be introduced in detail below with reference to the accompanying drawings.

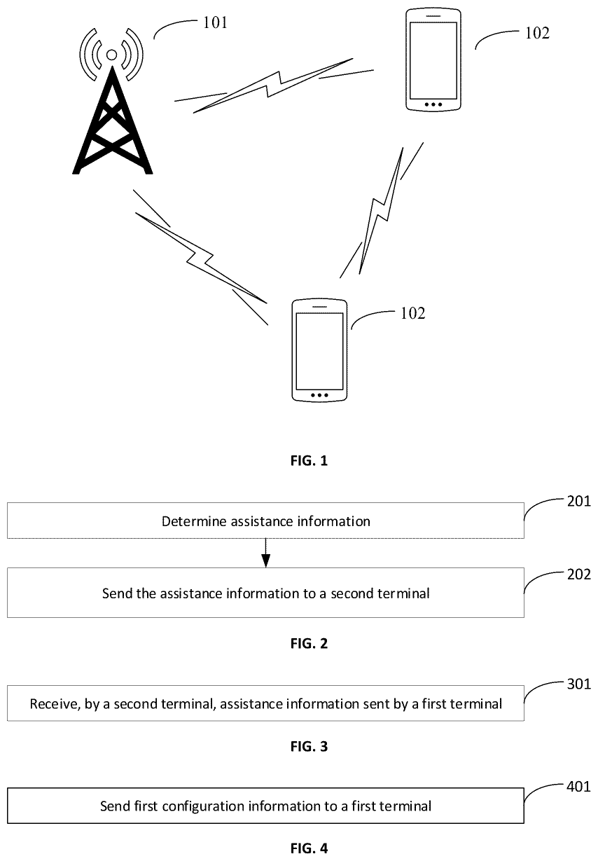

With reference to FIG. 2, FIG. 2 is a schematic flowchart of the method for assistance information interaction according to the embodiment of the present disclosure. It should be noted that this method may be applied to a sidelink unlicensed band (Sidelink-U) scenario. This method may be performed by a first terminal. Optionally, the first terminal may work in a sending resource allocation mode such as mode 1 or mode 2. As shown in FIG. 2, the method may include, but is not limited to, the following steps 201 and 202.

In step 201, assistance information is determined.

In the embodiment of the present disclosure, the assistance information is configured to assist the second terminal in sharing acquired COT with the first terminal.

In the embodiment of the present disclosure, the second terminal may be a terminal initiating shared COT, and the first terminal may be a responding terminal of the shared COT. The responding terminal of the shared COT may alternatively be referred to as a target terminal of the shared COT. Optionally, the first terminal may work in a sending resource allocation mode such as mode 1 or mode 2. The second terminal may also work in the sending resource allocation mode such as mode 1 or mode 2.

In the embodiment of the present disclosure, the first terminal may determine the assistance information. In a possible implementation, the first terminal may determine the assistance information based on a traffic pattern, at least one of an arrival period of traffic data or an arrival time of traffic data, a packet size, a quality of service (QOS), service priority, etc., or may also determine the assistance information based on service-related information between the first terminal and a third terminal. Then the initiating terminal of the shared COT is assisted in sharing the preempted COT with the first terminal, and the first terminal may use the shared COT. The third terminal may be another terminal in a unicast connection to the first terminal, or another terminal receiving a same broadcast service or multicast service as the first terminal.

In an implementation, the assistance information may include, but is not limited to, at least one of 1) to 7) as follows:
1) A traffic pattern. The traffic pattern may include a traffic pattern of the first terminal, or may include a traffic pattern of a third terminal. The third terminal may be another terminal in a unicast connection to the first terminal, or another terminal receiving the same broadcast service or multicast service as the first terminal. In this way, the first terminal provides the traffic pattern of the first terminal for the initiating terminal of the shared COT, the initiating terminal may be assisted in sharing preempted COT with the first terminal in combination with the traffic pattern of the first terminal, and then the first terminal may use the COT to send data to the initiating terminal. Alternatively, the first terminal may provide the traffic pattern of the third terminal for the initiating terminal of the shared COT, the initiating terminal may be assisted in sharing the preempted COT with the first terminal in combination with the traffic pattern of the third terminal (such as another terminal having a unicast (or multicast or broadcast) service with the first terminal device), and then the first terminal may use the COT to send data to the third terminal. Alternatively, the initiating terminal may be assisted in sharing the preempted COT with the third terminal, and then the third terminal may use the COT to send data, for example, to the first terminal.
2) A traffic periodicity. The traffic periodicity is configured to indicate the arrival period of the traffic data. The traffic periodicity may include a traffic periodicity of the first terminal, or may include a traffic periodicity of the third terminal. In this way, the first terminal provides the traffic periodicity of the first terminal for the initiating terminal of the shared COT, the initiating terminal may be assisted in sharing the preempted COT with the first terminal in combination with the traffic periodicity of the first terminal, and then the first terminal may use the COT to send data to the initiating terminal. Alternatively, the first terminal may provide the traffic periodicity of the third terminal for the initiating terminal of the shared COT, the initiating terminal may be assisted in sharing the preempted COT with the first terminal in combination with the traffic periodicity of the third terminal (such as another terminal having a unicast (or multicast or broadcast) service with the first terminal device), and then the first terminal may use the COT to send data to the third terminal. Alternatively, the initiating terminal may be assisted in sharing the preempted COT with the third terminal, and then the third terminal may use the COT to send data, for example, to the first terminal.
3) A timing offset. The timing offset is configured to indicate an offset of arrival time of the traffic data relative to a subframe #0 having a system frame number of SFN #0.
4) A packet size.
5) A quality of service (QOS) flow identifier associated with the traffic pattern.
6) Service priority.
7) A target address of the third terminal. The target address may be a layer 2 address of the third terminal.

As an instance, the first terminal may acquire the assistance information such as the traffic pattern, the traffic periodicity, the timing offset, the packet size, the QoS flow identifier associated with the traffic pattern, and the service priority of the first terminal, then the initiating terminal may know or estimate service information of the first terminal based on the assistance information, and the initiating terminal is assisted in sharing the preempted COT with the first terminal. Thus, it can be guaranteed that the first terminal can use the shared COT of the initiating terminal, the first terminal can use the COT to send the data to the initiating terminal, and the initiating terminal can be prevented from sharing the preempted COT with a responding terminal incapable of using the COT.

As an instance, the first terminal may acquire the assistance information such as the traffic pattern, the traffic periodicity, the timing offset, the packet size, the QoS flow identifier associated with the traffic pattern, and the service priority of the third terminal, and the target address of the third terminal, then the initiating terminal may know or estimate service information of the third terminal associated with the first terminal based on the assistance information, and the initiating terminal is assisted in sharing the preempted COT with the first terminal. Thus, it can be guaranteed that the first terminal can use the shared COT of the initiating terminal, and the first terminal can use the COT to send data to another terminal except the initiating terminal. Alternatively, the initiating terminal is assisted in sharing the preempted COT with the third terminal, and then the third terminal can use the COT to send the data, for example, to the first terminal. Thus, the initiating terminal can be prevented from sharing the preempted COT with a responding terminal incapable of using the COT.

That is, the first terminal may inform the second terminal of at least one of the traffic pattern or the target address (such as the layer 2 address) of another target terminal of the first terminal via the assistance information, so as to support COT sharing. Illustratively, the another target terminal may be another terminal in a unicast connection to the first terminal or another terminal receiving the same broadcast service or multicast service as the first terminal.

In an implementation, the assistance information may be carried via at least one of: a communication interface PC5 RRC message between terminals; an SL medium access control control element (MAC CE); or SCI. As an instance, the first terminal may send the assistance information via the PC5 RRC message, and the PC5 RRC message may be an RRC reconfiguration sidelink message. As another instance, the first terminal may send the assistance information via the SL MAC CE, or the first terminal may send the assistance information through the SCI. Alternatively, as another instance, the first terminal may send the assistance information via a combination of any two or three of the PC5 RRC message, the SL MAC CE, and the SCI, which is not limited in the present disclosure and is not repeated here.

In step 202, the assistance information is sent to the second terminal.

In this technical solution, by sending the assistance information from the first terminal, the initiating terminal of shared COT is assisted in sharing the acquired COT with the first terminal (that is, a responding terminal of the COT). Then the first terminal can use the shared COT to send data. Thus, the waste of the COT is avoided.

Optionally, the first terminal may send the assistance information to the second terminal after determining the assistance information. The first terminal may send the assistance information in a unicast form, or may send the assistance information in a multicast form, or may also send the assistance information in a broadcast form.

In some embodiments of the present disclosure, the first terminal may send the assistance information in the unicast form. In a possible implementation, the first terminal may determine the second terminal, and send the assistance information to the second terminal. The second terminal may be a terminal in the unicast connection to the first terminal. Optionally, at least one of the following is satisfied: a reference signal receiving power (RSRP) of a unicast link between the second terminal and the first terminal is greater than or equal to a predetermined threshold; or sidelink (SL) data to be sent to the second terminal exist in the first terminal.

As an instance, the first terminal may determine the second terminal in the following mode: the first terminal may determine the second terminal in the unicast connection to the first terminal. For example, the first terminal may determine one or more second terminals in the unicast connection to the first terminal. Illustratively, the first terminal may send the assistance information to the one or more second terminals in the unicast connection to the first terminal, or the first terminal may send the assistance information to all the second terminals in the unicast connection to the first terminal.

As another instance, the first terminal may determine the second terminal that is in the unicast connection to the first terminal and satisfies a condition. For example, the first terminal may send the assistance information to the second terminal that is in the unicast connection to the first terminal and satisfies the condition. In the embodiment of the present disclosure, the satisfied condition includes at least one of: the RSRP of the unicast link between the second terminal and the first terminal is greater than or equal to the predetermined threshold; or the SL data to be sent to the second terminal exist in the first terminal. The SL data may include, but is not limited to, at least one of PSSCH or PSCCH data.

For example, the first terminal may send the assistance information to one or some second terminals in the unicast connection to the first terminal, where the RSRP of the unicast link between the second terminal and the first terminal is greater than or equal to the predetermined threshold. For example, the first terminal may send the assistance information to one or some second terminals, where the second terminal is in the unicast connection to the first terminal, and the SL data to be sent to the second terminal exist in the first terminal. Alternatively, the first terminal may select one or some second terminals in the unicast connection to the first terminal based on the implementation, and send the assistance information to the selected second terminal.

In some embodiments of the present disclosure, the first terminal may send the assistance information in the multicast form. In a possible implementation, the first terminal may send the assistance information to the second terminal via the multicast using the target address. The target address is associated with a multicast service configured for the first terminal, and a same multicast service is configured for the first terminal and the second terminal; or the target address is associated with a multicast service that the first terminal is interested in at least one of receiving or sending, and at least one of the following is satisfied: the first terminal and the second terminal receive a same multicast service, or the first terminal and the second terminal send a same multicast service. As an instance, the target address is a target address of the multicast service. Optionally, how the first terminal selects one or more target addresses may be implemented by the first terminal. As an instance, the first terminal may select one or more target addresses associated with the multicast service to send the assistance information in the multicast form. The second terminal receiving the same multicast service as the first terminal may receive the assistance information. When receiving the assistance information, the second terminal may know or estimate the service information of the first terminal, and then may share the preempted COT with the first terminal in combination with the assistance information by, for example, sending shared COT indication information to the first terminal. Thus, the first terminal is enabled to use the COT.

In some embodiments of the present disclosure, the first terminal may send the assistance information in the broadcast form. In a possible implementation, the first terminal may send the assistance information to the second terminal via the broadcast using the target address. The target address is associated with a broadcast service configured for the first terminal, and a same broadcast service is configured for the first terminal and the second terminal; or the target address is associated with a broadcast service that the first terminal is interested in at least one of receiving or sending, and at least one of the following is satisfied: the first terminal and the second terminal receive a same broadcast service, or the first terminal and the second terminal send a same broadcast service. Optionally, how the first terminal selects one or more target addresses may be implemented by the first terminal. As an instance, the first terminal may select one or more target addresses associated with the broadcast service to send the assistance information in the broadcast form. The second terminal receiving the same broadcast service as the first terminal may receive the assistance information. When receiving the assistance information, the second terminal may know or estimate the service information of the first terminal, and then may share the preempted COT with the first terminal in combination with the assistance information by, for example, sending shared COT indication information to the first terminal. Thus, the first terminal is enabled to use the COT.

Optionally, in some embodiments of the present disclosure, the assistance information supports periodical reporting. In a possible implementation, the first terminal determines a sending period of the assistance information, and periodically sends the assistance information to the second terminal based on the sending period. Optionally, the sending period may be acquired via network configuration, or determined via terminal implementation, or configured by the second terminal.

As an instance, the first terminal may receive first configuration information sent by a network device, and the first configuration information includes the sending period. In this way, the first terminal may determine the sending period of the assistance information according to the first configuration information. For example, in a case where the first terminal is in an RRC connected state, the first terminal may acquire the first configuration information from the network device via dedicated RRC signaling, and may determine the sending period of the assistance information according to the first configuration information. Alternatively, in a case where the first terminal is in an RRC idle state or inactive state, the first terminal may acquire the first configuration information from the network device via a System Information Block (SIB), and may determine the sending period of the assistance information according to the first configuration information. Alternatively, in a case where the first terminal is in an out of coverage (OOC) state, the first terminal may acquire the sending period of the assistance information via pre-configuration.

As another instance, the first terminal may receive second configuration information sent by the second terminal, and the second configuration information includes the sending period. In this way, the first terminal may determine the sending period of the assistance information according to the second configuration information. For example, the second terminal may configure the sending period via a PC5-RRC message, and the PC5-RRC message may be an RRCReconfigurationSidelink. That is, the second terminal may carry the second configuration information via the PC5-RRC message. When receiving the PC5-RRC message carrying the second configuration information, the first terminal may determine the sending period of the assistance information according to the second configuration information.

As yet another instance, the first terminal may determine the sending period of the assistance information based on implementation of the first terminal.

It should be noted that a solution of periodically sending the assistance information is applicable to the unicast service, the multicast service, and the broadcast service, which is not limited in the present disclosure and is not repeated here.

Optionally, in some embodiments of the present disclosure, the assistance information supports triggering reporting. In a possible implementation, the first terminal determines that a triggering condition for reporting the assistance information is satisfied, and then sends the assistance information to the second terminal. The triggering condition may be at least one of: the assistance information differs from the assistance information sent last time; the unicast connection is initially established between the first terminal and the second terminal; or the first terminal initially establishes the multicast service or the broadcast service. That is, the triggering condition for the assistance information includes, but is not limited to, at least one of the following: the assistance information changes since last reporting; or initial reporting is performed, for example, the unicast connection is initially established, the multicast service is initially established, or the broadcast service is initially established.

As an instance, in a case where the first terminal device determines that the assistance information to be sent this time differs from the assistance information sent last time, the first terminal device sends the assistance information to be sent to the second terminal. In this way, the second terminal receiving the assistance information may share the acquired COT with the first terminal according to the assistance information, so as to support COT sharing.

As another instance, in a case where the first terminal determines that the unicast connection is initially established between the first terminal and the second terminal, the first terminal sends the assistance information to the second terminal. Then the second terminal is assisted in sharing the acquired COT with the first terminal to support the COT sharing.

As another instance, the first terminal determines that the first terminal initially establishes the multicast service, and then sends the assistance information to the second terminal via the multicast using the target address of the multicast service. For example, a high layer initially establishes a multicast service, and the high layer may inform an access stratum (AS) via an interior of the terminal. The first terminal receives the multicast service, and then sends the assistance information to the second terminal via the multicast using the target address of the multicast service. The second terminal receiving the same multicast service as the first terminal may receive the assistance information, and the second terminal may share the acquired COT with the first terminal according to the assistance information, so as to support the COT sharing.

As yet another instance, the first terminal determines that the first terminal initially establishes the broadcast service, and then sends the assistance information to the second terminal via the multicast using the target address of the broadcast service. For example, a high layer initially establishes a broadcast service, and the high layer may inform an access stratum (AS) via an interior of the terminal. The first terminal receives the broadcast service, and then sends the assistance information to the second terminal via the multicast using the target address of the broadcast service. The second terminal receiving the same broadcast service as the first terminal may receive the assistance information, and the second terminal may share the acquired COT with the first terminal according to the assistance information, so as to support the COT sharing.

Optionally, in some embodiments of the present disclosure, the assistance information supports request reporting. In a possible implementation, the first terminal receives an assistance information request sent by the second terminal. The assistance information request is configured to request the first terminal to send the assistance information to the second terminal. The first terminal sends the assistance information to the second terminal. It should be noted that a solution of reporting the assistance information based on the request is merely applicable to the unicast service. In a case where the first terminal receives the assistance information request from the second terminal, the first terminal triggers the assistance information to be reported to the second terminal.

As an instance, the first terminal determines that the assistance information request is received, and starts a timer. The timer is configured to control sending of the assistance information. The first terminal cancels generating or sending of the assistance information in a case where the timer is in operation and the assistance information is successfully sent, and stops the timer. As another instance, the first terminal determines that the assistance information request is received, starts the timer, and determines that the timer is expired, and the first terminal cancels the generating or sending of the assistance information.

That is, the first terminal may control the sending of the assistance information via the timer. In a case where the assistance information request is received, the first terminal starts the timer. During the operation of the timer, in a case where the assistance information is successfully sent, the first terminal cancels the assistance information and stops the timer. In a case where the timer is expired, the first terminal cancels the assistance information.

The expression “cancels the assistance information” refers to cancellation of the assistance information. For example, in a case where it is determined that the assistance information request is received, the timer is started, and the generating and the sending of the assistance information are triggered. In a case where the assistance information is triggered, but a report of the assistance information is not generated, and the timer is expired, the assistance information needs to be canceled. That is, the first terminal cancels the assistance information by, for example, ending generating of the report of the assistance information. Alternatively, in a case where the report of the assistance information is generated but is not sent, and the timer is expired, the assistance information also needs to be canceled. That is, the first terminal cancels the assistance information by, for example, deleting the generated report of the assistance information. Alternatively, there is another case that causes the timer to be expired before the assistance information is successfully sent, the first terminal needs to cancel the assistance information, which is not limited in the present disclosure and is not repeated here. For example, in a case where it is determined that the assistance information request is received, the timer is started, and the generating and the sending of the assistance information are triggered. In a case where the assistance information is triggered during the operation of the timer, and the report of the assistance information is generated and sent successfully, the assistance information needs to be canceled. That is, there is no need to try to send the assistance information again, and the first terminal cancels the assistance information.

Optionally, in some embodiments of the present disclosure, in a case where the first terminal determines that an allocation mode of a sidelink sending resource of the first terminal is a first allocation mode, and the first terminal has no available SL sending resource configured to send the assistance information, a scheduling request (SR) may be triggered. The SR is configured to request the SL sending resource for transmitting the assistance information. The first allocation mode may be a network dynamic scheduling mode of the sidelink sending resource (such as the mode 1 described above). For example, in a case where the first terminal runs in the mode 1 (that is, the allocation mode of the sidelink sending resource of the first terminal is the mode in which the network dynamically schedules the sidelink sending resource), and has no SL sending resources configured to transmit the assistance information, the first terminal may trigger the scheduling request (SR) and report an SL-BSR to the network device. Then the network device is assisted in scheduling the SL sending resource, and the first terminal may use the SL sending resource to send the assistance information.

It is worth noting that the responding terminal of the COT may use the COT shared by the initiating terminal in a case where the following two conditions are satisfied: a condition 1 that the receiving terminal of a data packet sent using the COT by the responding terminal of the COT includes at least the initiating terminal of the COT or another terminal indicated by the shared COT indication information; and a condition 2 that there is a requirement for a CAPC of the data packet of the responding terminal, that is, the CAPC of the data packet of the responding terminal within the shared COT is less than or equal to a CAPC carried via the initiating terminal in the shared COT indication information. Thus, in a case where these two conditions (that is, the condition 1 and the condition 2) cannot be satisfied, the responding terminal cannot use the COT shared by the initiating terminal, and waste of the COT is caused accordingly. In order to solve this problem, in the embodiment of the present disclosure, the assistance information is sent by the first terminal to the initiating terminal of the shared COT, then the initiating terminal is assisted in sharing the acquired COT with the first terminal, and the first terminal may be referred to as the responding terminal of the COT. The second terminal (that is, the initiating terminal of the shared COT) receives the assistance information, and determines whether the first terminal may satisfy the use conditions (such as the condition 1 and the condition 2) of the shared COT according to the assistance information. In a case where the first terminal satisfies the use conditions of the shared COT, the initiating terminal of the shared COT may share the COT with the first terminal, that is, send the shared COT indication information to the first terminal. In this way, the COT can be shared with the first terminal that satisfies the conditions, then the first terminal can use the COT, the initiating terminal can be prevented from sharing the preempted COT with a responding terminal incapable of using the COT, and the waste of the COT can be avoided.

It can be understood that the embodiments describe the implementation of the method for assistance information interaction of the embodiments of the present disclosure from the first terminal side. The embodiments of the present disclosure further provide another method for assistance information interaction, and the implementation of the method for assistance information interaction will be described from a second terminal side. With reference to FIG. 3, FIG. 3 is a schematic flowchart of another method for assistance information interaction according to the embodiment of the present disclosure. It should be noted that this method may be applied to a sidelink unlicensed band (Sidelink-U) scenario. This method may be performed by the second terminal. As shown in FIG. 3, the method may include, but is not limited to, the following step 301.

In step 301, assistance information sent by a first terminal is received by a second terminal.

In the embodiment of the present disclosure, the assistance information is configured to assist the second terminal in sharing acquired COT with the first terminal.

In this technical solution, an initiating terminal of shared COT receives the assistance information sent by the first terminal and shares the acquired COT with the first terminal (that is, a responding terminal of the COT). Then the first terminal can use the shared COT to send data. Thus, the waste of the COT is avoided.

Optionally, the second terminal may work in a sending resource allocation mode such as mode 1 or mode 2. The first terminal may also work in the sending resource allocation mode such as mode 1 or mode 2. Optionally, the second terminal may be a terminal initiating shared COT, and the first terminal device may be a responding terminal of the shared COT. The responding terminal of the shared COT may alternatively be referred to as a target terminal of the shared COT.

In the embodiment of the present disclosure, the first terminal may determine the assistance information, and send the assistance information to the second terminal. Reference can be made to the description of the implementation that the first terminal determines the assistance information and sends the assistance information in the embodiment shown in FIG. 2 for an implementation that the first terminal determines the assistance information and sends the assistance information, which is not limited in the present disclosure and is not repeated here. The second terminal may receive the assistance information sent by the first terminal.

Optionally, the first terminal may send the assistance information in a unicast form, or may send the assistance information in a multicast form, or may also send the assistance information in a broadcast form. In a possible implementation, the second terminal may receive the assistance information sent by the first terminal in the unicast form. A unicast connection exists between the second terminal and the first terminal. Optionally, at least one of the following is satisfied: a reference signal receiving power (RSRP) of a unicast link between the first terminal and the second terminal is greater than or equal to a predetermined threshold; or sidelink (SL) data to be sent to the second terminal exist in the first terminal.

In another possible implementation, the second terminal may receive the assistance information sent by the first terminal in the multicast form. As an instance, the second terminal receives the assistance information sent by the first terminal via multicast using a target address. The target address is associated with a multicast service configured for the first terminal, and a same multicast service is configured for the first terminal and the second terminal; or the target address is associated with a multicast service that the first terminal is interested in at least one of receiving or sending, and at least one of the following is satisfied: the first terminal and the second terminal receive a same multicast service, or the first terminal and the second terminal send a same multicast service.

In another possible implementation, the second terminal may receive the assistance information sent by the first terminal in the broadcast form. As an instance, the second terminal receives the assistance information sent by the first terminal via broadcast using a target address. The target address is associated with a broadcast service configured for the first terminal, and a same broadcast service is configured for the first terminal and the second terminal; or the target address is associated with a broadcast service that the first terminal is interested in at least one of receiving or sending, and at least one of the following is satisfied: the first terminal and the second terminal receive a same broadcast service, or the first terminal and the second terminal send a same broadcast service.

Optionally, in some embodiments of the present disclosure, the assistance information supports periodical reporting. In a possible implementation, the first terminal determines a sending period of the assistance information, and periodically sends the assistance information based on the sending period. The second terminal may periodically receive the assistance information sent by the first terminal. Optionally, the sending period may be acquired via network configuration, or determined via terminal implementation, or configured by the second terminal. It should be noted that a solution of periodically sending the assistance information is applicable to the unicast service, the multicast service, and the broadcast service, which is not limited in the present disclosure and is not repeated here.

Optionally, in some embodiments of the present disclosure, the second terminal may send second configuration information to the first terminal. The second configuration information includes the sending period of the assistance information. In this way, the first terminal may determine the sending period of the assistance information according to the second configuration information, and the first terminal may periodically send the assistance information to the second terminal based on the sending period.

Optionally, in some embodiments of the present disclosure, the assistance information supports request reporting. In a possible implementation, the second terminal may send an assistance information request to the first terminal. The assistance information request is configured to request the first terminal to send the assistance information to the second terminal. The second terminal receives the assistance information sent by the first terminal. It should be noted that a solution of reporting the assistance information based on the request is merely applicable to the unicast service. In a case where the first terminal receives the assistance information request from the second terminal, the first terminal triggers the assistance information to be reported to the second terminal.

In an implementation, the assistance information may include, but is not limited to, at least one of:
1) A traffic pattern. The traffic pattern may include a traffic pattern of the first terminal, or may include a traffic pattern of a third terminal. The third terminal may be another terminal in a unicast connection to the first terminal, or another terminal receiving the same broadcast service or multicast service as the first terminal. In this way, the first terminal provides the traffic pattern of the first terminal for the initiating terminal of the shared COT, the initiating terminal may be assisted in sharing preempted COT with the first terminal in combination with the traffic pattern of the first terminal, and then the first terminal may use the COT to send data to the initiating terminal. Alternatively, the first terminal may provide the traffic pattern of the third terminal for the initiating terminal of the shared COT, the initiating terminal may be assisted in sharing the preempted COT with the first terminal in combination with the traffic pattern of the third terminal (such as another terminal having the unicast (or multicast or broadcast) service with the first terminal device), and then the first terminal may use the COT to send data to the third terminal. Alternatively, the initiating terminal may be assisted in sharing the preempted COT with the third terminal, and then the third terminal may use the COT to send data, for example, to the first terminal.
2) A traffic periodicity. The traffic periodicity is configured to indicate an arrival period of the traffic data. The traffic periodicity may include a traffic periodicity of the first terminal, or may include a traffic periodicity of the third terminal. In this way, the first terminal provides the traffic periodicity of the first terminal for the initiating terminal of the shared COT, the initiating terminal may be assisted in sharing the preempted COT with the first terminal in combination with the traffic periodicity of the first terminal, and then the first terminal may use the COT to send data to the initiating terminal. Alternatively, the first terminal may provide the traffic periodicity of the third terminal for the initiating terminal of the shared COT, the initiating terminal may be assisted in sharing the preempted COT with the first terminal in combination with the traffic periodicity of the third terminal (such as another terminal having a unicast (or multicast or broadcast) service with the first terminal device), and then the first terminal may use the COT to send data to the third terminal. Alternatively, the initiating terminal may be assisted in sharing the preempted COT with the third terminal, and then the third terminal may use the COT to send data, for example, to the first terminal.
3) A timing offset. The timing offset is configured to indicate an offset of arrival time of the traffic data relative to a subframe #0 having a system frame number of SFN #0.
4) A packet size.
5) A quality of service (QOS) flow identifier associated with the traffic pattern.
6) Service priority.
7) A target address of the third terminal. The target address may be a layer 2 address of the third terminal.

As an instance, the first terminal may acquire the assistance information such as the traffic pattern, the traffic periodicity, the timing offset, the packet size, the QoS flow identifier associated with the traffic pattern, and the service priority of the first terminal, then the initiating terminal may know or estimate service information of the first terminal based on the assistance information, and the initiating terminal is assisted in sharing the preempted COT with the first terminal. Thus, it can be guaranteed that the first terminal can use the shared COT of the initiating terminal, the first terminal can use the COT to send the data to the initiating terminal, and the initiating terminal can be prevented from sharing the preempted COT with a responding terminal incapable of using the COT.

As an instance, the first terminal may acquire the assistance information such as the traffic pattern, the traffic periodicity, the timing offset, the packet size, the QoS flow identifier associated with the traffic pattern, and the service priority of the third terminal, and the target address of the third terminal, then the initiating terminal may know or estimate service information of the third terminal associated with the first terminal based on the assistance information, and the initiating terminal is assisted in sharing the preempted COT with the first terminal. Thus, it can be guaranteed that the first terminal can use the shared COT of the initiating terminal, and the first terminal can use the COT to send data to another terminal except the initiating terminal. Alternatively, the initiating terminal is assisted in sharing the preempted COT with the third terminal, and then the third terminal can use the COT to send the data, for example, to the first terminal. Thus, the initiating terminal can be prevented from sharing the preempted COT with a responding terminal incapable of using the COT.

That is, the first terminal may inform the second terminal of at least one of the traffic pattern or the target address (such as the layer 2 address) of another target terminal of the first terminal via the assistance information, so as to support COT sharing. Illustratively, the another target terminal may be another terminal in a unicast connection to the first terminal or another terminal receiving the same broadcast service or multicast service as the first terminal.

In an implementation, the assistance information may be carried via at least one of the following: a PC5 RRC message; an SL MAC CE; or SCI. As an instance, the first terminal may send the assistance information via the PC5 RRC message, and the PC5 RRC message may be an RRC reconfiguration sidelink message. As another instance, the first terminal may send the assistance information via the SL MAC CE, or the first terminal may send the assistance information through the SCI. Alternatively, as another instance, the first terminal may send the assistance information via a combination of any two or three of the PC5 RRC message, the SL MAC CE, and the SCI, which is not limited in the present disclosure and is not repeated here.

By implementing the embodiment of the present disclosure, the sharing second terminal (that is, the initiating terminal of the COT) receives the assistance information sent by the first terminal, and shares the acquired COT with the first terminal (that is, a responding terminal of the COT), so as to support COT sharing. Then the first terminal can use the shared COT to send data. Thus, waste of the COT is avoided.

It can be understood that the embodiments describe the implementation of the method for assistance information interaction of the embodiments of the present disclosure from the first terminal side and the second terminal side. The embodiments of the present disclosure further provide a configuration method, and the implementation of the configuration method will be described below from a network device side. With reference to FIG. 4, FIG. 4 is a schematic flowchart of the configuration method according to the embodiment of the present disclosure. It should be noted that this method may be applied to a sidelink unlicensed band (Sidelink-U) scenario. This method may be performed by the network device. As shown in FIG. 4, the method may include, but is not limited to, the following step 401.

In step 401, first configuration information is sent to a first terminal.

In the embodiment of the present disclosure, the first configuration information includes a sending period of assistance information. The sending period is configured to instruct the first terminal to periodically send the assistance information to a second terminal. The assistance information is configured to assist the second terminal in sharing acquired channel occupancy time (COT) with the first terminal, and the second terminal is a terminal initiating shared COT.

Optionally, the second terminal may work in a sending resource allocation mode such as mode 1 or mode 2. The first terminal may also work in the sending resource allocation mode such as mode 1 or mode 2. Optionally, the second terminal may be a terminal initiating shared COT, and the first terminal device may be a responding terminal of the shared COT. The responding terminal of the shared COT may alternatively be referred to as a target terminal of the shared COT.

In the embodiment of the present disclosure, the network device may send the first configuration information to the first terminal. The first terminal receives the first configuration information, and may determine the sending period of the assistance information according to the first configuration information. The first terminal may periodically send the assistance information to the second terminal based on the sending period, and the assistance information is configured to assist the second terminal in sharing acquired channel occupancy time (COT) with the first terminal. The second terminal receives the assistance information, and may share the acquired COT with the first terminal according to the assistance information, and the first terminal may be referred to as the responding terminal of the COT. The second terminal receives the assistance information, and may determine whether the first terminal may satisfy use conditions (such as a condition 1 and a condition 2) of the shared COT according to the assistance information. In a case where the first terminal satisfies the use conditions of the shared COT, the initiating terminal of the shared COT may share the COT with the first terminal, that is, send shared COT indication information to the first terminal. In this way, the COT can be shared with the first terminal that satisfies the conditions, then the first terminal can use the COT, the initiating terminal can be prevented from sharing the preempted COT with a responding terminal incapable of using the COT, and the waste of the COT can be avoided.

In the embodiment of the present disclosure, reference can be made to the descriptions of the embodiments shown in FIG. 2 and FIG. 3 for an implementation that the first terminal sends the assistance information and the second terminal receives the assistance information, which is not limited in the present disclosure and is not repeated here.

Optionally, in some embodiments of the present disclosure, in a case where the first terminal determines that an allocation mode of a sidelink sending resource of the first terminal is a network dynamic scheduling mode of the sidelink sending resource (such as the mode 1 described above), and the first terminal has no available SL sending resource configured to send the assistance information, a scheduling request (SR) may be triggered. The SR is configured to request the SL sending resource for transmitting the assistance information. The network device may receive the scheduling request (SR) sent by the first terminal, and the SR is configured to request the SL sending resource for transmitting the assistance information. The network device allocates the SL sending resource to the first terminal, and the SL sending resource is configured to transmit the assistance information.

In an implementation, the assistance information may include, but is not limited to, at least one of:
1) A traffic pattern. The traffic pattern may include a traffic pattern of the first terminal, or may include a traffic pattern of a third terminal. The third terminal may be another terminal in a unicast connection to the first terminal, or another terminal receiving the same broadcast service or multicast service as the first terminal. In this way, the first terminal provides the traffic pattern of the first terminal for the initiating terminal of the shared COT, the initiating terminal may be assisted in sharing the preempted COT with the first terminal in combination with the traffic pattern of the first terminal, and then the first terminal may use the COT to send data to the initiating terminal. Alternatively, the first terminal may provide the traffic pattern of the third terminal for the initiating terminal of the shared COT, the initiating terminal may be assisted in sharing the preempted COT with the first terminal in combination with the traffic pattern of the third terminal (such as another terminal having a unicast (or multicast or broadcast) service with the first terminal device), and then the first terminal may use the COT to send data to the third terminal. Alternatively, the initiating terminal may be assisted in sharing the preempted COT with the third terminal, and then the third terminal may use the COT to send data to the first terminal, for example.
2) A traffic periodicity. The traffic periodicity is configured to indicate the arrival period of the traffic data. The traffic periodicity may include a traffic periodicity of the first terminal, or may include a traffic periodicity of the third terminal. In this way, the first terminal provides the traffic periodicity of the first terminal for the initiating terminal of the shared COT, the initiating terminal may be assisted in sharing the preempted COT with the first terminal in combination with the traffic periodicity of the first terminal, and then the first terminal may use the COT to send data to the initiating terminal. Alternatively, the first terminal may provide the traffic periodicity of the third terminal for the initiating terminal of the shared COT, the initiating terminal may be assisted in sharing the preempted COT with the first terminal in combination with the traffic periodicity of the third terminal (such as another terminal having a unicast (or multicast or broadcast) service with the first terminal device), and then the first terminal may use the COT to send data to the third terminal. Alternatively, the initiating terminal may be assisted in sharing the preempted COT with the third terminal, and then the third terminal may use the COT to send data, for example, to the first terminal.
3) A timing offset. The timing offset is configured to indicate an offset of arrival time of the traffic data relative to a subframe #0 having a system frame number of SFN #0.
4) A packet size.
5) A quality of service (QOS) flow identifier associated with the traffic pattern.
6) Service priority.
7) A target address of the third terminal. The target address may be a layer 2 address of the third terminal.

As an instance, the first terminal may acquire the assistance information such as the traffic pattern, the traffic periodicity, the timing offset, the packet size, the QoS flow identifier associated with the traffic pattern, and the service priority of the first terminal, then the initiating terminal may know or estimate service information of the first terminal based on the assistance information, and the initiating terminal is assisted in sharing the preempted COT with the first terminal. Thus, it can be guaranteed that the first terminal can use the shared COT of the initiating terminal, the first terminal can use the COT to send the data to the initiating terminal, and the initiating terminal can be prevented from sharing the preempted COT with a responding terminal incapable of using the COT.

As an instance, the first terminal may acquire the assistance information such as the traffic pattern, the traffic periodicity, the timing offset, the packet size, the QoS flow identifier associated with the traffic pattern, and the service priority of the third terminal, and the target address of the third terminal, then the initiating terminal may know or estimate service information of the third terminal associated with the first terminal based on the assistance information, and the initiating terminal is assisted in sharing the preempted COT with the first terminal. Thus, it can be guaranteed that the first terminal can use the shared COT of the initiating terminal, and the first terminal can use the COT to send data to another terminal except the initiating terminal. Alternatively, the initiating terminal is assisted in sharing the preempted COT with the third terminal, and then the third terminal can use the COT to send the data, for example, to the first terminal. Thus, the initiating terminal can be prevented from sharing the preempted COT with a responding terminal incapable of using the COT.

That is, the first terminal may inform the second terminal of at least one of the traffic pattern or the target address (such as the layer 2 address) of another target terminal of the first terminal via the assistance information, so as to support COT sharing. Illustratively, the another target terminal may be another terminal in a unicast connection to the first terminal or another terminal receiving the same broadcast service or multicast service as the first terminal.

In an implementation, the assistance information may be carried via at least one of the following: a PC5 RRC message; an SL MAC CE; or SCI. As an instance, the first terminal may send the assistance information via the PC5 RRC message, and the PC5 RRC message may be an RRC reconfiguration sidelink message. As another instance, the first terminal may send the assistance information via the SL MAC CE, or the first terminal may send the assistance information through the SCI. Alternatively, as another instance, the first terminal may send the assistance information via a combination of any two or three of the PC5 RRC message, the SL MAC CE, and the SCI, which is not limited in the present disclosure and is not repeated here.

By implementing the embodiment of the present disclosure, the network device configures the sending period of the assistance information for the first terminal, the first terminal can periodically send the assistance information to the second terminal according to the sending period. The initiating terminal of the COT is assisted in sharing the acquired COT with the first terminal (that is, the responding terminal of the COT). The second terminal (that is, the initiating terminal of the shared COT) receives the assistance information, and determines whether the first terminal may satisfy the use conditions (that is, condition 1 and the condition 2 described above) of the shared COT according to the assistance information. In a case where the first terminal satisfies the use conditions of the shared COT, the initiating terminal of the shared COT may share the COT with the first terminal, that is, send the shared COT indication information to the first terminal. In this way, the COT can be shared with the first terminal that satisfies the conditions, then the first terminal can use the shared COT to send data, and the waste of the COT can be avoided.

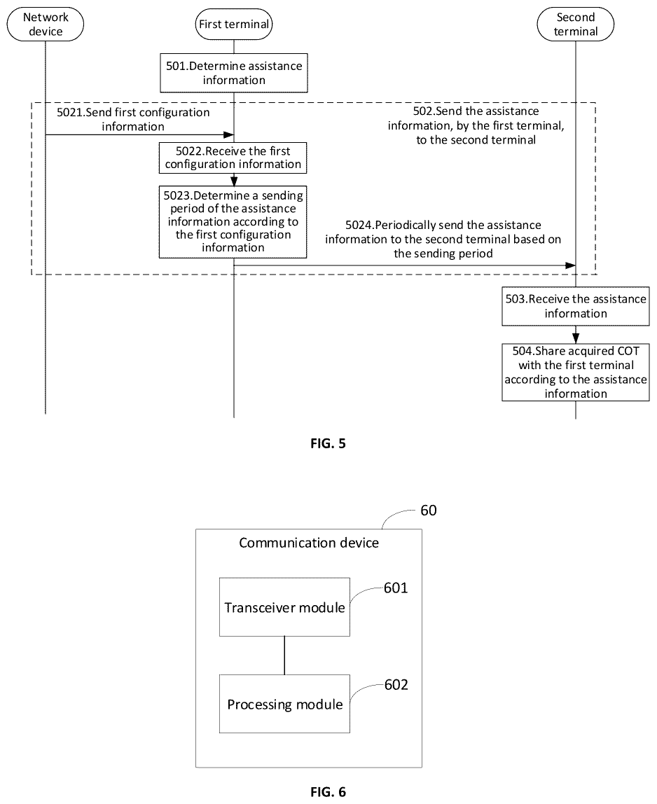

With reference to FIG. 5, FIG. 5 is a schematic flowchart of yet another method for assistance information interaction according to the embodiment of the present disclosure. It should be noted that the method may be performed by a communication system, and the communication system includes a first terminal, a second terminal, and a network device. An interaction flow of the communication system may include, but is not limited to the following steps 501, 502, 503, and 504.

In step 501, assistance information is determined by a first terminal.

In the embodiment of the present disclosure, the assistance information is configured to assist the second terminal in sharing acquired COT with the first terminal.

In the embodiment of the present disclosure, an implementation of step 501 may adopt any method in the embodiments, which is not limited and is not repeated here.

In step 502, the assistance information is sent by the first terminal.

Optionally, in some embodiments of the present disclosure, the assistance information supports periodical reporting. In a possible implementation, step 502 may include, but is not limited to, the following steps 5021, 5022, 5023, and 5024. In step 5021, the network device may send first configuration information to the first terminal, and the first configuration information includes a sending period of the assistance information. In step 5022, the first terminal receives the first configuration information. In step 5023, the sending period of the assistance information is determined according to the first configuration information. In step 5024, the assistance information is periodically sent to the second terminal based on the sending period. It should be noted that step 5021 and step 5022 may be performed before step 501, or step 5021 and step 5022 may be performed after step 501, or step 5021 and step 5022 may be performed simultaneously with step 501, which is not limited in the present disclosure.

In the embodiment of the present disclosure, an implementation of step 502 may adopt any method in the embodiments, which is not limited and is not repeated here.

In step 503, the assistance information sent by the first terminal is received by the second terminal.

In the embodiment of the present disclosure, an implementation of step 503 may adopt any method in the embodiments, which is not limited and is not repeated here.

In step 504, the second terminal shares the acquired COT with the first terminal according to the assistance information.

In an implementation, the second terminal receives the assistance information, and determines whether the first terminal may satisfy the use conditions (that is, a condition 1 and a condition 2 described above) of the shared COT according to the assistance information. In a case where the first terminal satisfies the use conditions of the shared COT, the initiating terminal of the shared COT may share the COT with the first terminal, that is, send the shared COT indication information to the first terminal. In this way, the COT can be shared with the first terminal that satisfies the conditions, then the first terminal can use the COT, the initiating terminal can be prevented from sharing the preempted COT with a responding terminal incapable of using the COT, and the waste of the COT can be avoided.

In the embodiments according to the present disclosure, the method according to the embodiment of the present disclosure is introduced from the perspectives of the first terminal, the second terminal, and the network device. In order to perform the functions in the method according to the embodiment of the present disclosure, the first terminal, the second terminal, and the network device may include hardware structures and software modules, and the functions are implemented in the form of the hardware structure, the software module, or a combination of the hardware structure and the software module. One of the functions may be performed by the hardware structure, the software module, or the combination of the hardware structure and the software module.

With reference to FIG. 6, FIG. 6 is a schematic structural diagram of a communication device 60 according to the embodiment of the present disclosure. The communication device 60 shown in FIG. 6 may include a transceiver module 601 and a processing module 602. The transceiver module 601 may include at least one of a sending module or a receiving module. The sending module is configured to implement a sending function, and the receiving module is configured to implement a receiving function. The transceiver module 601 may implement at least one of the sending function or the receiving function.

The communication device 60 may be a device for assistance information interaction. The device for assistance information interaction may be a terminal device (such as the first terminal in the method embodiment), a device in the terminal device, or a device matchable with the terminal device. Alternatively, the communication device 60 may be a device for assistance information interaction. The device for assistance information interaction may be a terminal device (such as the second terminal in the method embodiment), a device in the terminal device, or a device matchable with the terminal device. Alternatively, the communication device 60 may be a network device, a device in the network device, or a device matchable with the network device.

The communication device 60 is the device for assistance information interaction. The device for assistance information interaction may be the terminal device (such as the first terminal in the method embodiment). The processing module 602 is configured to determine assistance information. The assistance information is configured to assist the second terminal in sharing acquired channel occupancy time (COT) with the device for assistance information interaction, and the second terminal is a terminal initiating shared COT. The transceiver module 601 is configured to send the assistance information to the second terminal.

In an implementation, the processing module 602 is further configured to determine the second terminal. A unicast connection exists between the second terminal and the device for assistance information interaction.

In a possible implementation, at least one of the following is satisfied: a reference signal receiving power (RSRP) of a unicast link between the second terminal and the device for assistance information interaction is greater than or equal to a predetermined threshold; or sidelink (SL) data to be sent to the second terminal exist in the device for assistance information interaction.

In a possible implementation, the transceiver module 601 is specifically configured to send the assistance information to the second terminal via multicast using a target address. The target address is associated with a multicast service configured for the device for assistance information interaction, and a same multicast service is configured for the device for assistance information interaction and the second terminal; or the target address is associated with a multicast service that the device for assistance information interaction is interested in at least one of receiving or sending, and at least one of the following is satisfied: the device for assistance information interaction and the second terminal receive a same multicast service, or the device for assistance information interaction and the second terminal send a same multicast service.

In a possible implementation, the transceiver module 601 is specifically configured to send the assistance information to the second terminal via broadcast using a target address. The target address is associated with a broadcast service configured for the device for assistance information interaction, and a same broadcast service is configured for the device for assistance information interaction and the second terminal; or the target address is associated with a broadcast service that the device for assistance information interaction is interested in at least one of receiving or sending, and at least one of the following is satisfied: the device for assistance information interaction and the second terminal receive a same broadcast service, or the device for assistance information interaction and the second terminal send a same broadcast service.

In an implementation, the processing module 602 is further configured to determine a sending period of the assistance information. The transceiver module 601 is further configured to periodically send the assistance information to the second terminal based on the sending period.

In a possible implementation, the transceiver module 601 is further configured to receive first configuration information sent by a network device. The processing module 602 is further configured to determine the sending period of the assistance information according to the first configuration information.

In a possible implementation, the processing module 602 is further configured to determine the sending period of the assistance information based on implementation of the device for assistance information interaction.

In a possible implementation, the transceiver module 601 is further configured to receive second configuration information sent by the second terminal. The processing module 602 is further configured to determine the sending period of the assistance information according to the second configuration information.

In an implementation, the processing module 602 is further configured to determine that a triggering condition for reporting the assistance information is satisfied.

In a possible implementation, the triggering condition is at least one of: the assistance information differs from assistance information sent last time; a unicast connection is initially established between the device for assistance information interaction and the second terminal; the device for assistance information interaction initially establishes a multicast service; or the device for assistance information interaction initially establishes a broadcast service.

In a possible implementation, the transceiver module 601 is further configured to receive an assistance information request sent by the second terminal. The assistance information request is configured to request the device for assistance information interaction to send the assistance information to the second terminal.

In a possible implementation, the processing module 602 is further configured to determine that the assistance information request is received; start a timer, where the timer is configured to control sending of the assistance information; cancel generating or sending of the assistance information in a case where the timer is in operation and the assistance information is successfully sent; and stop the timer.

In a possible implementation, the processing module 602 is further configured to determine that the assistance information request is received; start a timer, where the timer is configured to control sending of the assistance information; determine that the timer is expired; and cancel generating or sending of the assistance information.

In an implementation, the processing module 602 is further configured to determine that an allocation mode of a sidelink sending resource of the device for assistance information interaction is a network dynamic scheduling mode, and the device for assistance information interaction has no available SL sending resource configured to send the assistance information; and trigger a scheduling request (SR), where the SR is configured to request the SL sending resource for transmitting the assistance information.

In an implementation, the assistance information includes at least one of: a traffic pattern; a traffic periodicity, where the traffic periodicity is configured to indicate an arrival period of traffic data; a timing offset, where the timing offset is configured to indicate an offset of arrival time of the traffic data relative to a subframe #0 having a system frame number of SFN #0; a packet size; a quality of service (QOS) flow identifier associated with the traffic pattern; service priority; or a target address of a third terminal, where the third terminal is another terminal in a unicast connection to the device for assistance information interaction, or another terminal receiving the same broadcast service or multicast service as the device for assistance information interaction.

In an implementation, the assistance information is carried via at least one of the following: a communication interface PC5 radio resource control (RRC) message, an SL medium access control control element (MAC CE), or sidelink control information (SCI).

The communication device 60 is the device for assistance information interaction. The device for assistance information interaction may be the terminal device (such as the second terminal in the method embodiment). The transceiver module 601 is configured to receive assistance information sent by the first terminal. The assistance information is configured to assist the device for assistance information interaction in sharing acquired channel occupancy time (COT) with the first terminal, and the device for assistance information interaction is a terminal initiating shared COT.

In a possible implementation, a unicast connection exists between the device for assistance information interaction and the first terminal.

In a possible implementation, at least one of the following is satisfied: a reference signal receiving power (RSRP) of a unicast link between the first terminal and the device for assistance information interaction is greater than or equal to a predetermined threshold; or sidelink (SL) data to be sent to the device for assistance information interaction exist in the first terminal.

In a possible implementation, the transceiver module 601 is specifically configured to receive the assistance information sent by the first terminal via multicast using a target address. The target address is associated with a multicast service configured for the first terminal, and a same multicast service is configured for the first terminal and the device for assistance information interaction; or the target address is associated with a multicast service that the first terminal is interested in at least one of receiving or sending, and at least one of the following is satisfied: the first terminal and the device for assistance information interaction receive a same multicast service, or the first terminal and the device for assistance information interaction send a same multicast service.

In a possible implementation, the transceiver module 601 is specifically configured to receive the assistance information sent by the first terminal via broadcast using a target address. The target address is associated with a broadcast service configured for the first terminal, and a same broadcast service is configured for the first terminal and the device for assistance information interaction; or the target address is associated with a broadcast service that the first terminal is interested in at least one of receiving or sending, and at least one of the following is satisfied: the first terminal and the device for assistance information interaction receive a same broadcast service, or the first terminal and the device for assistance information interaction send a same broadcast service.

In a possible implementation, the transceiver module is 601 specifically configured to periodically receive the assistance information sent by the first terminal.

In a possible implementation, the transceiver module 601 is further configured to send second configuration information to the first terminal. The second configuration information includes a sending period of the assistance information.

In an implementation, the transceiver module 601 is further configured to send an assistance information request to the first terminal. The assistance information request is configured to request the first terminal to send the assistance information to the device for assistance information interaction.

In an implementation, the assistance information includes at least one of: a traffic pattern; a traffic periodicity, where the traffic periodicity is configured to indicate an arrival period of traffic data; a timing offset, where the timing offset is configured to indicate an offset of arrival time of the traffic data relative to a subframe #0 having a system frame number of SFN #0; a packet size; a quality of service (QOS) flow identifier associated with the traffic pattern; service priority; or a target address of a third terminal, where the third terminal is another terminal in a unicast connection to the first terminal, or another terminal receiving the same broadcast service or multicast service as the first terminal.

In an implementation, the assistance information is carried via at least one of the following: a PC5 radio resource control (RRC) message, an SL medium access control control element (MAC CE), or sidelink control information (SCI).

The communication device 60 is the network device: The transceiver module 601 is configured to send first configuration information to a first terminal. The first configuration information includes a sending period of assistance information, and the sending period is configured to instruct the first terminal to periodically send the assistance information to a second terminal. The assistance information is configured to assist the second terminal in sharing acquired channel occupancy time (COT) with the first terminal, and the second terminal is a terminal initiating shared COT.

In an implementation, the transceiver module 601 is further configured to receive a scheduling request (SR) sent by the first terminal, and the SR is configured to request a sidelink (SL) sending resource for transmitting the assistance information. The processing module 602 is configured to allocate the SL sending resource to the first terminal, and the SL sending resource is configured to transmit the assistance information.

In an implementation, the assistance information includes at least one of: a traffic pattern; a traffic periodicity, where the traffic periodicity is configured to indicate an arrival period of traffic data; a timing offset, where the timing offset is configured to indicate an offset of arrival time of the traffic data relative to a subframe #0 having a system frame number of SFN #0; a packet size; a quality of service (QOS) flow identifier associated with the traffic pattern; service priority; or a target address of a third terminal, where the third terminal is another terminal in a unicast connection to the first terminal, or another terminal receiving the same broadcast service or multicast service as the first terminal.

In an implementation, the assistance information is carried via at least one of the following: a PC5 radio resource control (RRC) message, an SL medium access control control element (MAC CE), or sidelink control information (SCI).

With respect to the device in the embodiment described above, specific methods by which the modules perform operations have been described in detail in the embodiments relating to the method, and will not be described in detail here.

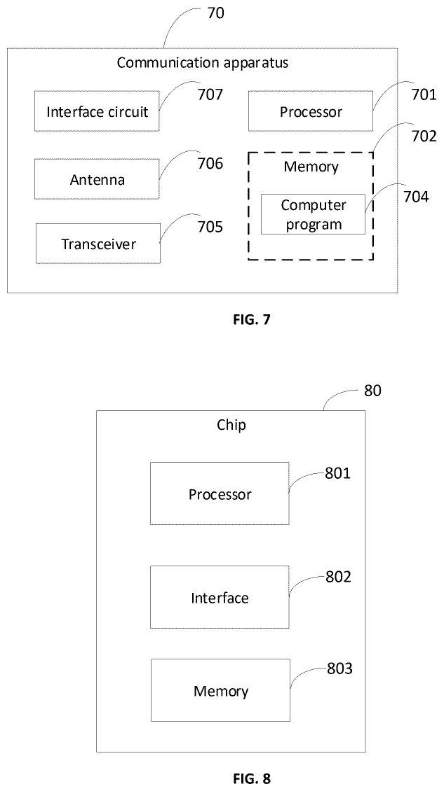

With reference to FIG. 7, FIG. 7 is a schematic structural diagram of another communication device 70 according to the embodiment of the present disclosure. The communication device 70 may be a network device, or may be a terminal device (such as the first terminal and the second terminal in the foregoing method embodiment), or may be a chip, a chip system, or a processor that supports the network device to implement the method, or may be a chip, a chip system, or a processor that supports the terminal device to implement the method. The device may be configured to implement the method described in the method embodiment, and reference can be made to the description in the method embodiment for details.

The communication device 70 may include one or more processors 701. The processor 701 may be a general-purpose processor or a special-purpose processor, for example, a baseband processor or a central processing unit. The baseband processor may be configured to process communication protocols and communication data, and the central processor may be configured to control the communication device (such as a base station, a baseband chip, the terminal device, a terminal device chip, a distributed unit (DU), or a centralized unit (CU)), execute a computer program, and process data of the computer program.

Optionally, the communication device 70 may further include one or more memories 702. A computer program 704 may be stored in the memory, and the processor 701 executes the computer program 704, so as to cause the communication device 70 to perform the method described in the method embodiment. Optionally, data may also be stored in the memory 702. The communication device 70 and the memory 702 may be set separately or integrated together.

Optionally, the communication device 70 may further include a transceiver 705 and an antenna 706. The transceiver 705 may be referred to as a transceiver unit, a transceiver machine, a transceiver circuit, etc., and is configured to implement a transceiving function. The transceiver 705 may include a receiver and a transmitter, and the receiver may be referred to as a receiver machine, a receiving circuit, etc., and is configured to implement a receiving function. The transmitter may be referred to as a transmitter machine or a transmitting circuit, etc., and is configured to implement a transmitting function.

Optionally, the communication device 70 may further include one or more interface circuits 707. The interface circuit 707 is configured to receive code instructions and transmit the code instructions to the processor 701. The processor 701 runs the code instructions, to cause the communication device 70 to perform the method described in the method embodiment.

The communication device 70 is the terminal device (such as the first terminal in the foregoing method embodiment). The processor 701 is configured to perform step 201 in FIG. 2, or perform step 501 and step 5023 in FIG. 5. The transceiver 705 is configured to perform step 202 in FIG. 2, or perform step 502, step 5022, and step 5024 in FIG. 5.

The communication device 70 is the terminal device (such as the second terminal in the foregoing method embodiment). The transceiver 705 is configured to perform step 301 in FIG. 3, or perform step 503 in FIG. 5. The processor 701 is configured to perform step 504 in FIG. 5.

The communication device 70 is the network device: The transceiver 705 is configured to perform step 401 in FIG. 4, or perform step 5021 in FIG. 5.

In an implementation mode, the processor 701 may include the transceiver configured to implement receiving and transmitting functions. For example, the transceiver may be the transceiver circuit, the interface, or the interface circuit. The transceiver circuit, the interface, or the interface circuit configured to implement the receiving and transmitting functions may be separated or integrated. The transceiver circuit, the interface, or the interface circuit may be configured to read and write codes/data, or the transceiver circuit, the interface, or the interface circuit may be configured to transmit or transfer a signal.

In an implementation mode, the processor 701 may store a computer program. The computer program runs on the processor 701, so as to cause the communication device 70 to perform the method described in the method embodiment. The computer program may be solidified in the processor 701. In such a case, the processor 701 may be implemented by hardware.

In an implementation, the communication device 70 may include a circuit. The circuit may implement the function of sending, receiving, or communication in the method embodiment. The processor and the transceiver described in the present disclosure may be implemented on an integrated circuit (IC), an analog IC, a radio frequency integrated circuit (RFIC), a mixed-signal IC, an application specific integrated circuit (ASIC), a printed circuit board (PCB), an electronic device, etc. The processor and the transceiver may alternatively be manufactured by various IC process technologies, such as a complementary metal oxide semiconductor (CMOS), nMetal-oxide-semiconductor (NMOS), a positive channel metal oxide semiconductor (PMOS), a bipolar junction transistor (BJT), a bipolar CMOS (BiCMOS), silicon germanium (SiGe), and gallium arsenide (GaAs).

The communication device described in the embodiment may be the network device or the terminal device (such as the first terminal and the second terminal in the foregoing method embodiment), but the scope of the communication device described in the present disclosure is not limited to this. The structure of the communication device may not be limited by FIG. 7. The communication device may be an independent device or part of a larger device. For example, the communication device may be:
(1) an independent integrated circuit (IC), the chip, or a chip system or a subsystem;
(2) a set having one or more ICs. Optionally, the IC set may alternatively include a storage component configured to store data and the computer program;
(3) an application-specific integrated circuit (ASIC), such as a modem;
(4) a module that is embeddable in another device;
(5) the receiver, the terminal device, a smart terminal device, a cellular phone, a wireless device, a handset, a mobile unit, an in-vehicle device, the network device, a cloud device, an artificial intelligence device, etc. ; and
(6) a different device.

In a case where the communication device may be the chip or the chip system, reference can be made to the schematic structural diagram of the chip shown in FIG. 8. The chip shown in FIG. 8 includes a processor 801 and an interface 802. One or more processors 801 may be provided, and one or more interfaces 802 may be provided.

In a case where the chip is configured to implement the function of the terminal device (such as the first terminal in the method embodiment) in the embodiment of the present disclosure:

The processor 801 is configured to determine assistance information. The assistance information is configured to assist the second terminal in sharing acquired (COT) with the communication device, and the second terminal is a terminal initiating shared COT. The interface 802 is configured to send the assistance information to the second terminal.

In an implementation, the processor 801 is further configured to determine the second terminal. A unicast connection exists between the second terminal and the communication device.

In a possible implementation, at least one of the following is satisfied: a reference signal receiving power (RSRP) of a unicast link between the second terminal and the communication device is greater than or equal to a predetermined threshold; or sidelink (SL) data to be sent to the second terminal exist in the communication device.

In an implementation, the interface 802 is specifically configured to send the assistance information to the second terminal via the multicast using the target address. The target address is associated with a multicast service configured for the communication device, and a same multicast service is configured for the communication device and the second terminal; or the target address is associated with a multicast service that the communication device is interested in at least one of receiving or sending, and at least one of the following is satisfied: the communication device and the second terminal receive a same multicast service, or the communication device and the second terminal send a same multicast service.

In an implementation, the interface 802 is specifically configured to send the assistance information to the second terminal via the broadcast using the target address. The target address is associated with a broadcast service configured for the communication device, and a same broadcast service is configured for the communication device and the second terminal; or the target address is associated with a broadcast service that the communication device is interested in at least one of receiving or sending, and at least one of the following is satisfied: the communication device and the second terminal receive a same broadcast service, or the communication device and the second terminal send a same broadcast service.

In an implementation, the processor 801 is further configured to determine a sending period of the assistance information. The interface 802 is further configured to periodically send the assistance information to the second terminal based on the sending period.

In a possible implementation, the interface 802 is further configured to receive first configuration information sent by a network device. The processor 801 is further configured to determine the sending period of the assistance information according to the first configuration information.

In a possible implementation, the processor 801 is further configured to determine the sending period of the assistance information based on the implementation of the communication device.

In a possible implementation, the interface 802 is further configured to receive second configuration information sent by the second terminal. The processor 801 is further configured to determine the sending period of the assistance information according to the second configuration information.

In an implementation, the processor 801 is further configured to determine that a triggering condition for reporting the assistance information is satisfied.

In a possible implementation, the triggering condition is at least one of: the assistance information differs from assistance information sent last time, a unicast connection is initially established between the communication device and the second terminal, the communication device initially establishes a multicast service, or the communication device initially establishes a broadcast service.

In an implementation, the interface 802 is further configured to receive an assistance information request sent by the second terminal. The assistance information request is configured to request the communication device to send the assistance information to the second terminal.

In a possible implementation, the processor 801 is further configured to determine that the assistance information request is received; start a timer, where the timer is configured to control sending of the assistance information; cancel generating or sending of the assistance information in a case where the timer is in operation and the assistance information is successfully sent; and stop the timer.

In a possible implementation, the processor 801 is further configured to determine that the assistance information request is received; start a timer, where the timer is configured to control sending of the assistance information; determine that the timer is expired; and cancel generating or sending of the assistance information.

In an implementation, the processor 801 is further configured to determine that an allocation mode of a sidelink sending resource of the communication device is a network dynamic scheduling mode, and the communication device has no available SL sending resource configured to send the assistance information; and trigger a scheduling request (SR), where the SR is configured to request the SL sending resource for transmitting the assistance information.

In an implementation, the assistance information includes at least one of: a traffic pattern; a traffic periodicity, where the traffic periodicity is configured to indicate an arrival period of traffic data; a timing offset, where the timing offset is configured to indicate an offset of arrival time of the traffic data relative to a subframe #0 having a system frame number of SFN #0; a packet size; a quality of service (QOS) flow identifier associated with the traffic pattern; service priority; or a target address of a third terminal, where the third terminal is another terminal in a unicast connection to the communication device, or another terminal receiving the same broadcast service or multicast service as the communication device.

In an implementation, the assistance information is carried via at least one of the following: a communication interface PC5 radio resource control (RRC) message between terminals; an SL medium access control control element (MAC CE); or sidelink control information (SCI).

In a case where the chip is configured to implement the function of the terminal device (such as the second terminal in the method embodiment) in the embodiment of the present disclosure:

The interface 802 is configured to receive assistance information sent by a first terminal. The assistance information is configured to assist the communication device in sharing acquired channel occupancy time (COT) with the first terminal, and the communication device is a terminal initiating shared COT.

In a possible implementation, a unicast connection exists between the communication device and the first terminal.

In a possible implementation, at least one of the following is satisfied: a reference signal receiving power (RSRP) of a unicast link between the first terminal and the communication device is greater than or equal to a predetermined threshold; or sidelink (SL) data to be sent to the communication device exist in the first terminal.

In a possible implementation, the interface 802 is specifically configured to receive the assistance information sent by the first terminal via multicast using a target address. The target address is associated with a multicast service configured for the first terminal, and a same multicast service is configured for the first terminal and the communication device; or the target address is associated with a multicast service that the first terminal is interested in at least one of receiving or sending, and at least one of the following is satisfied: the first terminal and the communication device receive a same multicast service, or the first terminal and the communication device send a same multicast service.

In a possible implementation, the interface 802 is specifically configured to receive the assistance information sent by the first terminal via broadcast using a target address. The target address is associated with a broadcast service configured for the first terminal, and a same broadcast service is configured for the first terminal and the communication device; or the target address is associated with a broadcast service that the first terminal is interested in at least one of receiving or sending, and at least one of the following is satisfied: the first terminal and the communication device receive a same broadcast service, or the first terminal and the communication device receive a same broadcast send a same broadcast service.

In a possible implementation, the interface 802 is specifically configured to periodically receive the assistance information sent by the first terminal.

In a possible implementation, the interface 802 is further configured to send second configuration information to the first terminal. The second configuration information includes a sending period of the assistance information.

In a possible implementation, the interface 802 is further configured to send an assistance information request to the first terminal. The assistance information request is configured to request the first terminal to send the assistance information to the communication device.

In an implementation, the assistance information includes at least one of: a traffic pattern; a traffic periodicity, where the traffic periodicity is configured to indicate an arrival period of traffic data; a timing offset, where the timing offset is configured to indicate an offset of arrival time of the traffic data relative to a subframe #0 having a system frame number of SFN #0; a packet size; a quality of service (QOS) flow identifier associated with the traffic pattern; service priority; or a target address of a third terminal, where the third terminal is another terminal in a unicast connection to the first terminal, or another terminal receiving the same broadcast service or multicast service as the first terminal.

In an implementation, the assistance information is carried via at least one of the following: a PC5 radio resource control (RRC) message, an SL medium access control control element (MAC CE), or sidelink control information (SCI).

In a case where the chip is configured to implement the function of the network device in the embodiment of the present disclosure:

The interface 802 is configured to send the first configuration information to the first terminal. The first configuration information includes a sending period of assistance information, and the sending period is configured to instruct the first terminal to periodically send the assistance information to a second terminal. The assistance information is configured to assist the second terminal in sharing acquired channel occupancy time (COT) with the first terminal, and the second terminal is a terminal initiating shared COT.

In an implementation, the interface 802 is further configured to receive a scheduling request (SR) sent by the first terminal, and the SR is configured to request a sidelink (SL) sending resource for transmitting the assistance information. The processor 801 is configured to allocate the SL sending resource to the first terminal, and the SL sending resource is configured to transmit the assistance information.

As used herein, the term processor may refer to one processor that performs the defined functions or a plurality of processors that collectively perform defined functions, such that the execution of the individual defined functions may be divided amongst such processors.

In an implementation, the assistance information includes at least one of: a traffic pattern; a traffic periodicity, where the traffic periodicity is configured to indicate an arrival period of traffic data; a timing offset, where the timing offset is configured to indicate an offset of arrival time of the traffic data relative to a subframe #0 having a system frame number of SFN #0; a packet size; a quality of service (QOS) flow identifier associated with the traffic pattern; service priority; or a target address of a third terminal, where the third terminal is another terminal in a unicast connection to the first terminal, or another terminal receiving the same broadcast service or multicast service as the first terminal.

In an implementation, the assistance information is carried via at least one of the following: a PC5 radio resource control (RRC) message, an SL medium access control control element (MAC CE), or sidelink control information (SCI).

Optionally, the chip further includes a memory 803. The memory 803 is configured to store necessary computer programs and data.

Those skilled in the art can also understand that various illustrative logical blocks and steps listed in the embodiments of the present disclosure may be implemented by electronic hardware, computer software, or their combinations. Whether this function is implemented by the hardware or the software depends on a specific application and design requirements from the entire system. Those skilled in the art can use different methods to implement the described functions for each particular application, but such implementation should not be considered to fall beyond the protection scope of the embodiment of the present disclosure.

The embodiments of the present disclosure further provide a system for determining the duration of a sidelink. The system includes the communication device as the terminal device (such as the first terminal in the foregoing method embodiment) and the communication device as the terminal device (such as the second terminal in the foregoing method embodiment) in the foregoing embodiment of FIG. 6. Alternatively, the system includes the communication device as the terminal device (such as the first terminal in the foregoing method embodiment) and the communication device as the terminal device (such as the second terminal in the foregoing method embodiment) in the foregoing embodiment of FIG. 7.

The embodiments of the present disclosure further provide a system for determining the duration of a sidelink. The system includes the communication device as the terminal device (such as the first terminal in the foregoing method embodiment), the communication device as the terminal device (such as the second terminal in the foregoing method embodiment), and the communication device as the network device in the foregoing embodiment of FIG. 6. Alternatively, the system includes the communication device as the terminal device (such as the first terminal in the foregoing method embodiment), the communication device as the terminal device (such as the second terminal in the foregoing method embodiment), and the communication device as the network device in the foregoing embodiment of FIG. 7.

The present disclosure further provides a readable storage medium. The readable storage medium stores instructions. The instructions, when executed by a computer, implement the function of any of the method embodiments.

The present disclosure further provides a computer program product. The computer program product, when executed by a computer, implements the function of any of the method embodiments.

The embodiments may be implemented wholly or partially by the software, the hardware, firmware, or any combination. When implemented by the software, the embodiments may be implemented wholly or partially in the form of the computer program product. The computer program product includes one or more computer programs. When the computer program is loaded and executed on the computer, the flows or functions according to the embodiment of the present disclosure are generated wholly or partially. The computer may be a general-purpose computer, a special-purpose computer, a computer network, or another programmable device. The computer program may be stored in a computer-readable storage medium or transmitted from one computer-readable storage medium to another computer-readable storage medium. For example, the computer program may be transmitted from a website, a computer, a server, or a data center to another website, computer, server, or data center in a wired (such as a coaxial cable, an optical fiber, and a digital subscriber line (DSL)) or wireless (such as infrared, radio and microwave) mode. The computer-readable storage medium may be any available medium that the computer may access or a data storage device such as a server and a data center that includes one or more available media. The available medium may be a magnetic medium (for example, a floppy disk, a hard disk, and a magnetic tape), an optical medium (for example, a high-density digital video disc (DVD)), or a semiconductor medium (for example, a solid state disk (SSD)).

It can be understood by those skilled in the art that various numerical numbers such as first and second involved in the present disclosure are merely for the convenience of description distinguishing, rather than limiting the scope of the embodiment of the present disclosure, and also indicate the sequential order.

The term “at least one” in the present disclosure may also be described as one or more, and “plurality” or “more” may indicate two, three, four, or more, which is not limited in the present disclosure. In the embodiment of the present disclosure, for a technical feature, technical features in the technical feature are distinguished with “first,” “second,” “third,” “A,” “B,” “C,” and “D,” and no sequential order or size order is indicated among the technical features described with “first,” “second,” “third,” “A,” “B,” “C,” and “D.”

The correspondence relationship shown in each table in the present disclosure may be configured or predefined. The value of information in each table is merely illustrative and may be configured as another value, which is not limited to the present disclosure. When the correspondence relationship between information and parameters is configured, it is unnecessary to configure all correspondence relationships shown in each table. For example, in the table in the present disclosure, the correspondence relationships shown in some rows may alternatively not be configured. For example, appropriate variation adjustments can be made to the table, such as splitting and merging. The names of the parameters shown in headings in the tables may also adopt other names that may be understood by the communication device, and the values or expression modes of the parameters may also adopt other values or expression modes that may be understood by the communication device. Other data structures may also be used for implementing the tables, such as an array, a queue, a container, a stack, a linear table, a pointer, a linked list, a tree, a graph, a structure, a class, a heap, a hash table, or a hash table.

Pre-definition in the present disclosure may be understood as definition, advanced definition, storage, pre-storage, pre-negotiation, pre-configuration, curing, or pre-firing.

It can be conceived by those skilled in the art that the units and algorithm steps of instances described in conjunction with the embodiments disclosed here can be implemented by electronic hardware, or a combination of computer software and the electronic hardware. Whether these functions are performed by hardware or software depends on the specific application and design constraints of the technical solution. Those skilled in the art can use different methods to implement the described functions for each particular application, but such implementation should not be considered to fall beyond the scope of the present disclosure.

Those skilled in the art can clearly understand that for the convenience and conciseness of description, reference can be made to the corresponding processes in the foregoing method embodiments for the specific work processes of the system, device, and unit, which is not repeated here.

The implementations described above are merely specific implementations of the present disclosure, but the protection scope of the present disclosure is not limited to such implementations. Any change or substitution that is readily conceivable by those skilled in the art within the technical scope disclosed by the present disclosure should fall within the protection scope of the present disclosure. Thus, the protection scope of the present disclosure should be subject to the protection scope of the claims.

1. A method for assistance information interaction, performed by a first terminal, comprising:
determining assistance information, wherein the assistance information is configured to assist a second terminal in sharing acquired channel occupancy time (COT) with the first terminal, and the second terminal is a terminal initiating shared COT; and
sending the assistance information to the second terminal.

2. The method according to claim 1, further comprising:
determining the second terminal, wherein a unicast connection exists between the second terminal and the first terminal.

3. The method according to claim 2, wherein at least one of the following is satisfied:
a reference signal receiving power (RSRP) of a unicast link between the second terminal and the first terminal is greater than or equal to a predetermined threshold; or
sidelink (SL) data to be sent to the second terminal exists in the first terminal.

4. The method according to claim 1, wherein sending the assistance information to the second terminal comprises at least one of:
sending the assistance information to the second terminal via multicast using a target address, wherein the target address is associated with a multicast service configured for the first terminal, and a same multicast service is configured for the first terminal and the second terminal, or, the target address is associated with the multicast service that the first terminal is interested in at least one of receiving or sending, and at least one of the following is satisfied: the first terminal and the second terminal receive a same multicast service, or the first terminal and the second terminal send a same multicast service;
sending the assistance information to the second terminal via broadcast using the target address, wherein the target address is associated with a broadcast service configured for the first terminal, and a same broadcast service is configured for the first terminal and the second terminal; or, the target address is associated with a broadcast service that the first terminal is interested in at least one of receiving or sending, and at least one of the following is satisfied: the first terminal and the second terminal receive a same broadcast service, or the first terminal and the second terminal send a same broadcast service; or
determining a sending period of the assistance information, and sending the assistance information to the second terminal periodically based on the sending period.

5.-6. (canceled)

7. The method according to claim 4, wherein determining the sending period of the assistance information comprises:
receiving first configuration information sent by a network device, and determining the sending period of the assistance information according to the first configuration information; or
determining the sending period of the assistance information based on implementation of the first terminal; or
receiving second configuration information sent by the second terminal, and determining the sending period of the assistance information according to the second configuration information.

8. The method according to claim 1, further comprising:
determining that a triggering condition for reporting the assistance information is satisfied:
wherein the triggering condition is at least one of:
the assistance information differs from assistance information sent last time;
a unicast connection is initially established between the first terminal and the second terminal; or
the first terminal initially establishes a multicast service or initially establishes a broadcast service.

9. (canceled)

10. The method according to claim 1, further comprising:
receiving an assistance information request sent by the second terminal, wherein the assistance information request is configured to request the first terminal to send the assistance information to the second terminal.

11. The method according to claim 10, further comprising at least one of:
determining that the assistance information request is received;
starting a timer, wherein the timer is configured to control sending of the assistance information;
canceling generating or sending of the assistance information in a case where the timer is in operation and the assistance information is successfully sent; and
stopping the timer; or
determining that the assistance information request is received;
starting_the_timer, wherein the timer is configured to control sending of the assistance information;
determining that the timer is expired; and
canceling generating or sending of the assistance information.

12. (canceled)

13. The method according to claim 1, further comprising:
determining that an allocation mode of a sidelink sending resource of the first terminal is a network dynamic scheduling mode, and the first terminal has no available SL sending resource configured to send the assistance information; and
triggering a scheduling request (SR), wherein the SR is configured to request the SL sending resource for transmitting the assistance information.

14. The method according to claim 1, wherein the assistance information comprises at least one of:
a traffic pattern;
a traffic periodicity, wherein the traffic periodicity is configured to indicate an arrival period of traffic data;
a timing offset, wherein the timing offset is configured to indicate an offset of arrival time of the traffic data relative to a subframe having a system frame number of 0;
a packet size;
a quality of service (QOS) flow identifier associated with the traffic pattern;
service priority; or
a target address of a third terminal, wherein the third terminal is another terminal in a unicast connection to the first terminal, or another terminal receiving the same broadcast service or multicast service as the first terminal.

15. The method according to claim 1, wherein the assistance information is carried via at least one of:
a communication interface PC5 radio resource control (RRC) message;
an SL medium access control control element (MAC CE); or
sidelink control information (SCI).

16. A method for assistance information interaction, performed by a second terminal, comprising:
receiving assistance information sent by a first terminal, wherein the assistance information is configured to assist the second terminal in sharing acquired channel occupancy time (COT) with the first terminal, and the second terminal is a terminal initiating shared COT.

17. The method according to claim 16, wherein a unicast connection exists between the second terminal and the first terminal;
wherein at least one of the following is satisfied:
a reference signal receiving power (RSRP) of a unicast link between the first terminal and the second terminal is greater than or equal to a predetermined threshold; or
sidelink (SL) data to be sent to the second terminal exists in the first terminal.

18. (canceled)

19. The method according to claim 16, wherein receiving the assistance information sent by the first terminal comprises at least one of:
receiving the assistance information sent by the first terminal via multicast using a target address; wherein
the target address is associated with a multicast service configured for the first terminal, and a same multicast service is configured for the first terminal and the second terminal; or,
the target address is associated with the multicast service that the first terminal is interested in at least one of receiving or sending, and at least one of the following is satisfied: the first terminal and the second terminal receive a same multicast service, or the first terminal and the second terminal send a same multicast service;
receiving the assistance information sent by the first terminal via broadcast using the target address; wherein
the target address is associated with a broadcast service configured for the first terminal, and a same broadcast service is configured for the first terminal and the second terminal; or,
the target address is associated with a broadcast service that the first terminal is interested in at least one of receiving or sending, and at least one of the following is satisfied: the first terminal and the second terminal receive a same broadcast service, or the first terminal and the second terminal send a same broadcast service; or
receiving the assistance information sent by the first terminal periodically.

20.-21. (canceled)

22. The method according to claim 19, further comprising:
sending second configuration information to the first terminal, wherein the second configuration information comprises a sending period of the assistance information.

23. The method according to claim 16, further comprising:
sending an assistance information request to the first terminal, wherein the assistance information request is configured to request the first terminal to send the assistance information to the second terminal.

24.-27. (canceled)

28. A communication device, comprising:
one or more processors; and
a memory that stores a computer program, wherein the one or more processors collectively execute the computer program stored in the memory to cause the communication device to:
determine assistance information, wherein the assistance information is configured to assist a second terminal in sharing acquired channel occupancy time (COT) with the communication device, and the second terminal is a terminal initiating shared COT; and
send the assistance information to the second terminal.

29. A communication device, comprising:
one or more processors; and
a memory that stores a computer program, wherein the one or more processors collectively execute the computer program stored in the memory to cause the communication device to act as the second terminal and perform the method according to claim 16.

30. (canceled)

31. A non-transitory computer-readable storage medium storing instructions, wherein the instructions, when executed by the first terminal, cause the first terminal to perform the method according to claim 1.

32. A non-transitory computer-readable storage medium storing instructions, wherein the instructions, when executed by the second terminal, cause the second terminal to perform the method according to claim 16.
